(19) United States
(12) Patent Application Publication
(10) Pub. No.: US 2005/0060369 A1
(43) Pub. Date: Mar. 17, 2005

(54) Interactive live web broadcast establishment and method therefor

(76) Inventors: Gregory A. Cunningham, Ventura, CA (US); Warwick S. Price, Henderson, NV (US); Andy En Y. Wang, San Carlos, CA (US)

Correspondence Address: WEISS & MOY PC, 4204 NORTH BROWN AVENUE, SCOTTSDALE, AZ, 85251, US

(21) Appl. No.: 10/663,219

(22) Filed: Sep. 16, 2003

(51) Int. Cl. G06F 15/16

(52) U.S. Cl. 709/204

(57) ABSTRACT

A system for allowing interaction between individuals in an establishment and individuals remote from establishment is disclosed. The system has a server for transferring graphical and textual data to and from the establishment. A plurality of customer terminals are located in the establishment and coupled to the server. The customer terminals are used for ordering items in the establishment and for interacting with others in and remote from the establishment. At least one employee terminal is coupled to the server. The employee terminal is used for displaying items ordered by individuals in the establishment. This will allow employees to provide faster service to individuals in the establishment. A plurality of establishment video cameras are coupled to the server. The video cameras are used for transmitting graphical images from inside the establishment.

### BACKGROUND OF THE INVENTION

1. Field of the Invention

This invention relates generally to an eating/drinking establishment and, more specifically, to an interactive live web broadcast establishment where patrons in the establishment and at remote locations can interact with one another online.

2. Description of the Prior Art

Individuals that would like to meet and date other individuals are presently provided with a plurality of well known methods to attempt to do so. Dance clubs, social clubs, bars, and the like, are well known approaches to meeting other individuals. Often, however, these locations are flooded with loud music and a significant level of background noise. They can also be impersonal and foreign for infrequent patrons. As a result, these establishments are most inviting to younger individuals, or for the planned meeting of a group of persons. It can further be noted that the possibility of rejection, especially in a crowded club or bar room, makes such places quite intimidating to many single persons. Accordingly, most singles find the club/bar option unattractive.

Online or internet dating/matchmaking is another way for individuals to meet one another. The online/internet dating service industry has grown significantly in recent years. ComScore Media Medtrix has provided recent user information for a number of the larger personals/dating web-sites (there are over 200 on-line dating sites), as follows:

| | Number of Unique Users |
|---|---|
| Web-site | (as of July, 2002) |
| Match.com | 5,665,000 |
| Yahoo! Personals | 4,412,000 |
| Date.com | 2,295,000 |
| Matchmaker.com | 1,522,000 |
| Someonelikesyou.com | 1,237,000 |
| Dreammates.com | 983,000 |

In addition, a recent Jupiter Research study stated that more than 34 million people have visited online personal ad sites, and that the average user spends 13 hours a month on such sites.

Online/internet dating allows those who may be a little shy to interact with one another. Interaction can occur through emails, chat rooms, instant messaging, and the like. However, despite its growth, the online dating/personals industry continues to be plagued by the problem of users either misrepresenting themselves (e.g., as younger, more attractive (via outdated pictures or through misrepresentation of height/weight), more successful, etc.), or concealing important information (e.g., a criminal record, a drug or alcohol addiction, sexually transmitted diseases, a marriage, etc.). As of Dec. 11, 2002, there have been over 17,900 online dating horror stories, and some have ended tragically.

Therefore, a need existed to provide an improved place and method that allows individuals to meet and/or date other individuals. The improved place and method must overcome the problems associated with the prior art.

### SUMMARY OF THE INVENTION

In accordance with one embodiment of the present invention, it is an object of the present invention to provide an improved place and method that allows individuals to meet and/or date other individuals.

It is another object of the present invention to provide an improved place and method that allows individuals to meet and/or date other individuals must overcome the problems associated with the prior art.

### BRIEF DESCRIPTION OF THE EMBODIMENTS

In accordance with one embodiment of the present invention, a system for allowing interaction between individuals in an establishment and individuals remote from establishment is disclosed. The system has a server for transferring graphical and textual data to and from the establishment. A plurality of customer terminals are located in the establishment and coupled to the server. The customer terminals are used for ordering items in the establishment and for interacting with others in and remote from the establishment. At least one employee terminal is coupled to the server. The employee terminal is used for displaying items ordered by individuals in the establishment. This will allow employees to provide faster service to individuals in the establishment. A plurality of establishment video cameras are coupled to the server. The video cameras are used for transmitting graphical images from inside the establishment.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a simplified block diagram of the interactive live web broadcast establishment used in the present invention.

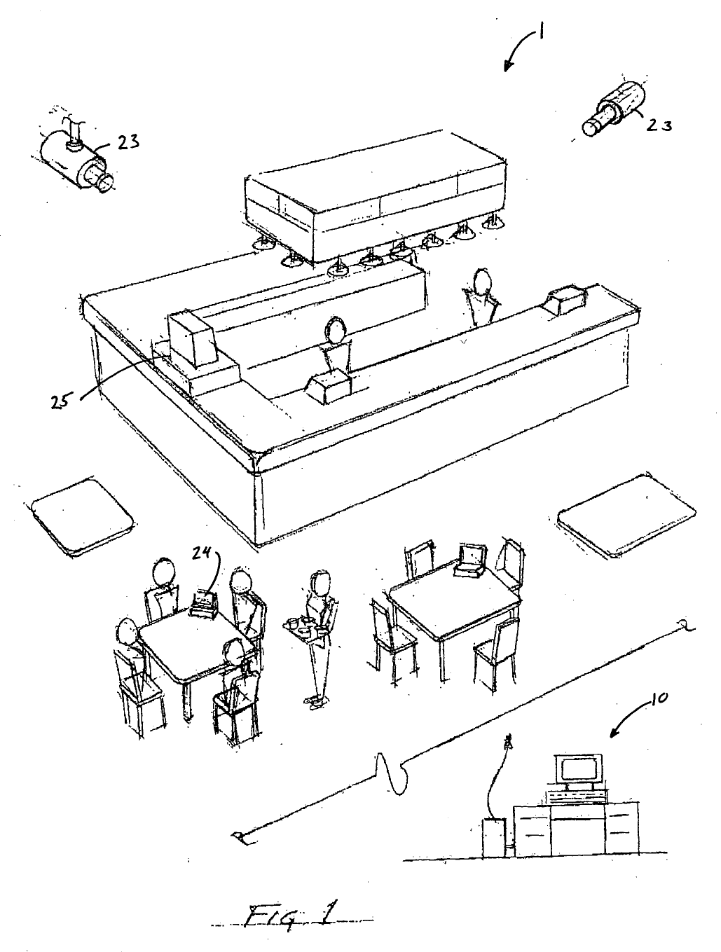

FIG. 2 is a simplified functional block diagram of the interactive live web broadcast establishment system of the present invention.

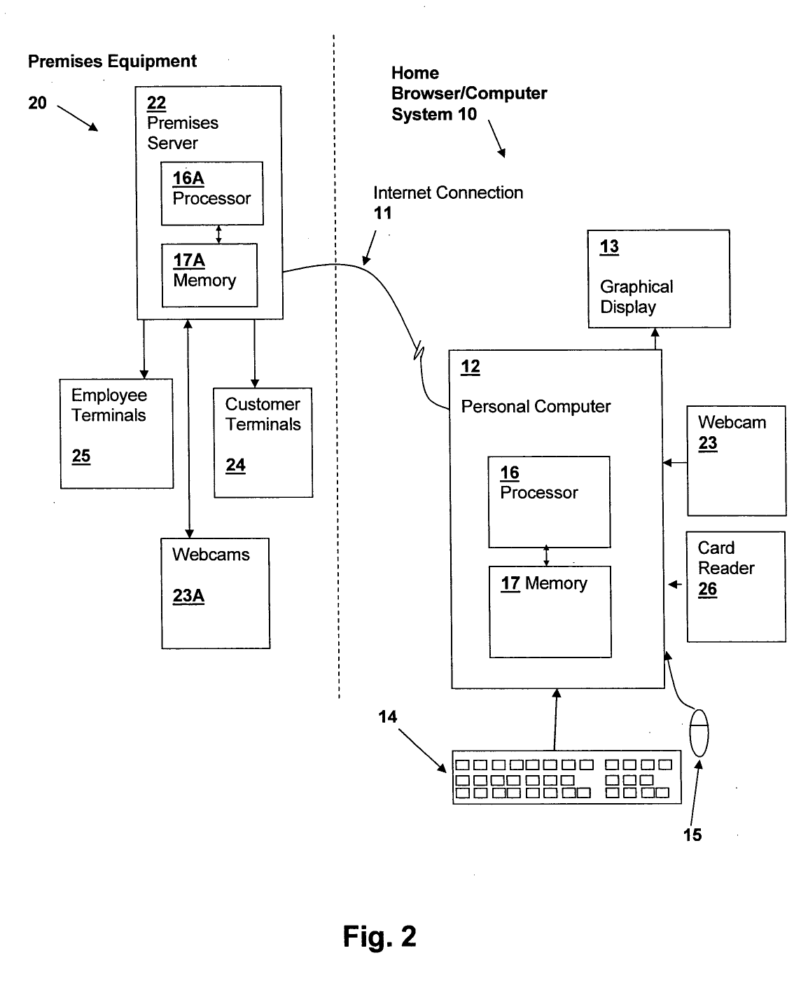

### DETAILED DESCRIPTION OF THE PREFERRED EMBODIMENT

Referring to the Figures, an interactive live web broadcast establishment and system 1 of the present invention is shown. The system 1 is comprised of two main components. The system 1 has a remote computer system 10 and premises equipment 20.

The remote computer system 10 is used by individuals who are not present at the establishment. The remote computer system 10 will allow individuals who are not in the establishment to observe, chat, and interact with customers in the establishment. The remote computer system 10 is in general, a standard home computer system 12. The computer system 12 will have a motherboard having a processor 16. Memory 17 is coupled to the processor 16. The memory 16 may be any type of memory such as dynamic, static, combinations thereof, and the like.

The computer system 12 will have one or more input/output devices coupled thereto. The input/output devices will allow one to input and transfer data from the computer system 12 to the premises equipment 20. The input devices may include one or more of the following: a keyboard 14, a mouse 15, a video camera 23, a card reader 26, and the like. The listing of the above should not be seen as to limit the scope of the present invention. The keyboard 14 and mouse 15 will allow one to input data and execute certain on screen commands. The video camera 23 will allow video and/or still images to be taken and transferred to the premises equipment 20 thus allowing interaction between the individual at the remote site and the people in the establishment. A card reading device 26 is also coupled to the computer system 12. The card reading device 26 will scan and read information on a card inserted into the card reading device 26. The card reading device 26 may be used to read credit/debit cards, membership cards, smartcards, and the like. The listing of the above should not be seen as to limit the scope of the present invention.

A graphical display 13 will also be coupled to the computer system 12. The graphical display 13 is used to show visual information to the person using the computer system 12. For example, the graphical display 13 may show live video data from the establishment. The graphical display 13 may further show a menu or other textual information from the establishment. The graphical display may be any type of computer monitor.

The computer system 12 has an internet connection 11. The internet connection 11 allows the computer system 12 to connect and transfer data to and from the premises equipment 20 via one or more servers. The internet connection 11 may be a phone line, a cable, ethernet connection, and the like. The listing of the above should not be seen as to limit the scope of the present invention.

The premises equipment 20 is comprised of a premises server 22. The server 22 is used to transfer data to and from the establishment where the system 1 is installed. The server 22 is further used to host the website of the establishment. The server 22 will generally have a processor 16A and memory 17A. The server 22 is coupled to one or more personal computers 12 via an internet connection 11.

The server 22 will be coupled to a plurality of cameras 23A. The cameras 23A will be located throughout the establishment. The cameras 23A will allow people coupled to the server 22 to observe people in the establishment and to see what's going on in the establishment.

The server 22 also has a plurality of customer terminals 24. The customer terminals 24 will allow one to order food/drinks and to interact with others in the establishment as well as those remote from the establishment. The customer terminals 24 may be a simple video display 13 having one or more input devices coupled to the server 22 for entering data (i.e., drink/food orders, online chat, etc.). The input devices would be similar to those described above.

Alternatively, the customer terminals 24 may be something more similar to that of the computer system 10. Thus, each customer terminals 24 will generally have a motherboard having a processor 16. Memory 17 is coupled to the processor 16. The memory 16 may be any type of memory such as dynamic, static, combinations thereof, and the like.

Each customer terminal 24 will have one or more input/output devices coupled thereto. The input/output devices will allow one to input and transfer data from the customer terminal 24 to the server 22. Thus, data may be transferred from the customer terminal 24 to a home computer system 12 via the server 22. The input devices may include one or more of the following: a keyboard 14, a mouse 15, a video camera 23, a card reader 26, and the like. The listing of the above should not be seen as to limit the scope of the present invention. The keyboard 14 and mouse 15 will allow one to input data and execute certain on screen commands. The video camera 23 will allow video and/or still images to be taken and transferred to the server 22 thus allowing interaction between individuals at the establishment and people at a remote site. A card reading device 26 is also coupled to the customer terminal 24. The card reading device 26 will scan and read information on a card inserted into the card reading device 26. The card reading device 26 may be used to read credit/debit cards, membership cards, smartcards, and the like. The listing of the above should not be seen as to limit the scope of the present invention.

A graphical display 13 will also be coupled to the customer terminal 24. The graphical display is used to show visual and/or textual information to the person using the computer system 12 in the establishment. The graphical display 13 may be any type of computer monitor.

Employee terminals 25 are also coupled to the server 22. The employee terminals 25 will allow employees of the establishment to see what a particular table in the establishment has ordered (i.e., food, drinks, etc.). This will allow the employees to better serve the items in a more timely manner.

In operation, the system 1 will operate in the following manner. A restaurant, bar or other establishment will have the premises equipment 20 installed. A plurality of customer terminals 24 will be installed wherein each table in the establishment will have one or more customer terminals 24. A plurality of video cameras 23 are positioned through out the establishment. Video cameras 23 may also be positioned at each table and or customer terminal 24. When a person arrives at the establishment, the customer can use the customer terminal 24 to input an order for food and/or a drink. This information will be sent to an employee terminal 25 via the server 22. An employee can then fill the customer's order.

Customer's may further interact with other customers via the customer terminal 24. Each customer terminal 24 will have some identification marker. Thus, one customer can send a text message, video message, video conference call, instant message, etc. to a specific customer at another customer terminal 24. Thus the system 1 will allow people in the establishment to interact with one another. A customer may further order drinks and/or food and have it delivered to another customer at another customer terminal 24.

A card reading device 26 may be coupled to the customer terminal 24. The card reading device may be used for several purposes. First, the card reading device 26 may be used so that customers at the customer terminal 24 may insert a credit card, debit card, or the like to pay for any food and/or drinks that are ordered. Second, the card reading device 26 may be used to read an establishment club card. For example, the use of a customer terminal 24 could be limited to those who are members of an establishment club. Card could be issued to club members. One could only access and use the customer terminal 24 by inserting the establishment club card into the card reading device 26.

Customers at remote locations can also interact with customers at the establishment. Customers may log onto a website using a remote computer system 10. Customers may then interact with other customers at a customer terminal 24. Since each customer terminal 24 will have some identification marker, remote customers can send a text message, video message, video conference call, etc. to a specific customer at a specific customer terminal 24. A remote customer may further order drinks and/or food and have it delivered to a customer at a specific customer terminal 24.

If a card reading device 26 is coupled to a remote computer system 10, the card reading device may be used for several purposes. First, the card reading device 26 may be used so that customers at a remote computer system 10 may insert a credit card, debit card, or the like to pay for any food and/or drinks that are ordered. Second, the card reading device 26 may be used to read an establishment club card. For example, access to the website may be limited to members of an establishment club. Cards could be issued to club members. One could only access and use the a remote computer system 10 by inserting the establishment club card into the card reading device 26.

It should be noted that the system 1 can still function without the use of a card reading device 26. Information can always be inputted into a remote computer system 10 or a customer terminal 24 by manually entering the data using an I/O device like a keyboard or a mouse.

While the invention has been particularly shown and described with reference to preferred embodiments thereof, it will be understood by those skilled in the art that the foregoing and other changes in form and details may be made therein without departing from the spirit and scope of the invention.

1. A system for allowing interaction between individuals in an establishment and individuals remote from establishment comprising:
a server for transferring graphical and textual data to and from the establishment;
a plurality of customer terminals located in the establishment and coupled to the server for ordering items in the establishment and for interacting with others in and remote from the establishment;
at least one employee terminals coupled to the server for displaying items ordered by individuals in the establishment; and
a plurality of establishment video cameras coupled to the server for transmitting graphical images.

2. A system for allowing interaction between individuals in an establishment and individuals remote from establishment in accordance with claim 1 further comprising at least one remote computer system coupled to the server via an internet connection for allowing individuals remote from the establishment to interact with individuals in the establishment and at one of the customer terminals.

3. A system for allowing interaction between individuals in an establishment and individuals remote from establishment in accordance with claim 1 wherein each of the plurality of customer terminals comprises:
a video display coupled to the server; and
at least one input/output device coupled to the server for entering food/drink orders and for transmitting data to and from other individuals.

4. A system for allowing interaction between individuals in an establishment and individuals remote from establishment in accordance with claim 3 wherein the customer terminals further comprises a card reading device coupled to the server.

5. A system for allowing interaction between individuals in an establishment and individuals remote from establishment in accordance with claim 3 wherein the customer terminals further comprises a video camera at each customer terminal coupled to the server.

6. A system for allowing interaction between individuals in an establishment and individuals remote from establishment in accordance with claim 2 wherein the remote computer system comprises:
a personal computer having a processor and memory;
input/output devices coupled to the personal computer for entering data;
a graphical display coupled to the personal computer for displaying data; and
an internet connection coupled to the personal computer for connecting the personal computer to the internet.

7. A system for allowing interaction between individuals in an establishment and individuals remote from establishment in accordance with claim 6 wherein the remote computer system further comprises a web camera coupled to the personal computer for transmitting graphical images from the remote computer system.

8. A system for allowing interaction between individuals in an establishment and individuals remote from establishment in accordance with claim 6 wherein the remote computer system further comprises a car reading device coupled to the personal computer.
